(19) United States
(12) Patent Application Publication
(10) Pub. No.: US 2004/0059022 A1
(43) Pub. Date: Mar. 25, 2004

(54) Aqueous resin dispersion and method for producing the same technical field

(76) Inventors: Fumitoshi Tsukiyama, Hyogo (JP); Kouichi Takawaki, Hyogo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/466,681

(22) PCT Filed: Sep. 27, 2002
(86) PCT No.: PCT/JP02/10134

(30) Foreign Application Priority Data
Jan. 25, 2002 (JP) 2002-17378
Jun. 26, 2002 (JP) 2002-186763

(51) Int. Cl. B05D 7/00

(52) U.S. Cl. 523/201

(57) ABSTRACT

The present invention provides an aqueous resin dispersion having a relatively low acid value and high viscosity and structural viscosity after alkali neutralization, and a method for producing the same. A core/shell-type aqueous resin dispersion comprising

a core/shell-type resin including:

a core part comprising a resin (C) having an acid value of not more than 20 and a hydroxyl group value of not more than 100 and being emulsion-polymerized from a polymerizable unsaturated monomer (c) containing neither acid group nor hydroxyl group, and optionally a hydroxyl group-containing polymerizable unsaturated monomer (b), and optionally an acid group-containing polymerizable unsaturated monomer (a), and a shell part comprising a resin (S) having an acid value of 30 to 150 and a hydroxyl group value of 10 to 100 and being emulsion-polymerized from the acid group-containing polymerizable unsaturated monomer (a), the hydroxyl group-containing polymerizable unsaturated monomer (b), and the polymerizable unsaturated monomer (c) containing neither acid group nor hydroxyl group.

### TECHNICAL FIELD

The present invention relates to an aqueous resin dispersion having an excellent thickening performance and a structural viscosity and comprising a synthetic resin emulsion which exerts an excellent curing performance when a melamine resin is used as a curing agent, and a method for producing the same.

### BACKGROUND ART

In various usages of a synthetic resin emulsion, there are cases, for example, where the electrostatic fiber implanting process of a short fiber pile is applied to various substrates such as an ABS resin, polystyrene, polyvinyl chloride, polypropylene and fabric, and where the synthetic resin emulsion is used for various automobile coating materials such as base coating materials and for constructions or building materials. Such usage of the synthetic resin emulsion requires excellent coating workability and coating suitability upon coating by use of various coating tools such as roll, coating bar, spray, air spray electrostatic coater (bell-shape type and the like), and also requires exerting of high alkali thickening performance and structural viscosity upon neutralizing acid components in the resin with basic compounds such as ammonia and various amines for the purpose of ensuring a sagging resistance of thick coating film immediately after coating. In addition, melamine cross-linking performance is also required. However, it has been difficult for conventional aqueous resin dispersions to obtain a high viscosity and structural viscosity at a relatively low acid value.

More specifically, in the use for electrostatic fiber implanting process, for example, nylon or polypropylene pile is electrostatically implanted under a high voltage after applying resin on substrate. In this process, the conventional aqueous resin dispersions allow an implanted pile to randomly slip or move due to an insufficient viscosity or structural viscosity of the applied resin, resulting in considerably poor appearance of processed article after drying.

Also in the use for waterborne automobile base coat, particularly in the case of metallic coating, an aqueous base coating composition mixed with an aluminum paste produced generally from an aluminum flake pigment, a carboxyl group-containing and hydroxyl group-containing acrylic resin dispersions thickened by neutralizing with a basic compound (alkali) such as dimethylethanolamine, and a melamine resin is electrostatically coated on the surface of the coating film which is formed by cation electric deposition on a steel plate followed by coating inner coating material on a steel plate and then heat curing. In such case, conventional acrylic resin dispersions allow the coating material to sag along the vertical surface due to an insufficient viscosity or structural viscosity after coating resulting from an insufficient alkali thickening performance, or allow the aluminum orientation to be deviated due to the strenuous movement of the coating material after coating, resulting in considerably poor appearance of the dried and cured coating film. In addition, the conventional acrylic resin dispersions with a sufficient viscosity and structural viscosity contain the excessive amount of carboxylic acid, which results in considerably poor water resistance of the coating film obtained.

Under such a circumstance, development of an aqueous resin dispersion having a relatively low acid value, which allows the resultant coating film to have an excellent water resistance, and also having a high viscosity and structural viscosity after being neutralized with alkali has been awaited.

### DISCLOSURE OF THE INVENTION

### Object of the Invention

Accordingly, an object of the present invention is to solve the problems associated with the above described conventional art, and to provide an aqueous resin dispersion having a relatively low acid value and also having a high viscosity and structural viscosity after being neutralized with alkali, and a method for producing the same.

### SUMMARY OF THE INVENTION

The present inventors have made an effort and then found that the above described object can be achieved by a core/shell-type aqueous resin dispersion obtained as follows: an acid group-containing monomer which is used in no amount or in a very small amount, a hydroxyl group-containing monomer, and any other monomers such as (meth)acrylate and/or styrenic monomers are emulsion-polymerized using a radical polymerization initiator, and then the acid group-containing monomer, the hydroxyl group-containing monomer, and any other monomers such as a (meth)acrylate and/or styrenic monomers are emulsion-polymerized in such a ratio as to produce a resin having a relatively low acid value to obtain a core/shell-type aqueous resin dispersion. Thus the present invention is completed.

That is, the present invention is a core/shell-type aqueous resin dispersion comprising

a core/shell-type resin including:

a core part comprising a resin (C) having an acid value of not more than 20 and a hydroxyl group value of not more than 100 and being emulsion-polymerized from a polymerizable unsaturated monomer (c) containing neither acid group nor hydroxyl group, and optionally a hydroxyl group-containing polymerizable unsaturated monomer (b), and optionally an acid group-containing polymerizable unsaturated monomer (a); and

a shell part comprising a resin (S) having an acid value of 30 to 150 and a hydroxyl group value of 10 to 100 and being emulsion-polymerized from the acid group-containing polymerizable unsaturated monomer (a), the hydroxyl group-containing polymerizable unsaturated monomer (b), and the polymerizable unsaturated monomer (c) containing neither acid group nor hydroxyl group,

wherein said core/shell-type aqueous resin dispersion has an initial viscosity of not less than 3,000 mPa·S after thickening with alkali, and a structural viscosity index of not less than 250 after thickening with alkali, which is represented as a ratio between a low shear region (0.1 sec⁻¹) viscosity and a high shear region (100 sec⁻¹) viscosity:

(structural viscosity index)=(low shear region viscosity)/(high shear region viscosity).

In the present invention, thickening with alkali means thickening upon addition of an alkali to the aqueous resin dispersion with a nonvolatile content adjusted to 20% by weight.

The present invention is a core/shell-type aqueous resin dispersion obtained by:

(1) preparing an aqueous dispersion of a core component resin (C) having an acid value of not more than 20 and a hydroxyl group value of not more than 100 by emulsion-polymerizing a polymerizable unsaturated monomer (c) containing neither acid group nor hydroxyl group, and optionally a hydroxyl group-containing polymerizable unsaturated monomer (b), and optionally an acid group-containing polymerizable unsaturated monomer (a); and

(2) preparing a shell component resin (S) having an acid value of 30 to 150 and a hydroxyl group value of 10 to 100 by emulsion-polymerizing the acid group-containing polymerizable unsaturated monomer (a), the hydroxyl group-containing polymerizable unsaturated monomer (b), and the polymerizable unsaturated monomer (c) containing neither acid group nor hydroxyl group in the aqueous dispersion of the resin (C) prepared in step (1);

wherein said core/shell-type aqueous resin dispersion has an initial viscosity of not less than 3,000 mPa·S after thickening with alkali, and a structural viscosity index of not less than 250 after thickening with alkali, which is represented as a ratio between a low shear region (0.1 sec⁻¹) viscosity and a high shear region (100 sec⁻¹):

(structural viscosity index)=(low shear region viscosity)/(high shear region viscosity).

The present invention is the core/shell-type aqueous resin dispersion, wherein the polymerizable unsaturated monomer (c) containing neither acid group nor hydroxyl group includes at least one monomer selected from the group consisting of (meth)acrylates, styrenic monomers, (meth)acrylonitrile and (meth)acrylamide.

The present invention is the core/shell-type aqueous resin dispersion, wherein the total weight Sw of the polymerizable unsaturated monomers used in the preparation of the resin (S) and the total weight Cw of the polymerizable unsaturated monomers used in the preparation of the resin (C) satisfy the relationship represented by the following equation:

10/100≦Sw/(Sw+Cw)≦50/100.

The present invention is the core/shell-type aqueous resin dispersion, wherein a cross-linkable monomer is used as an additional copolymerization component in the preparation of said resin (C).

The present invention is the core/shell-type aqueous resin dispersion, wherein a cross-linkable monomer is used as an additional copolymerization component in the preparation of said resin (S).

The present invention is the core/shell-type aqueous resin dispersion having a low shear region (0.1 sec⁻¹) viscosity of not less than 5,000 Pa·S and having a high shear region (100 sec⁻¹) viscosity of not more than 20 Pa·S after thickening with alkali.

The present invention is the aqueous resin dispersion wherein the change rate of the viscosity after being allowed to stand for 1 week is within 10% from the initial viscosity after thickening with alkali.

In addition, the present invention is a method for producing a core/shell-type aqueous resin dispersion comprising the steps of:

(1) preparing an aqueous dispersion of a core component resin (C) having an acid value of not more than 20 and a hydroxyl group value of not more than 100 by emulsion-polymerizing a polymerizable unsaturated monomer (c) containing neither acid group nor hydroxyl group, and optionally a hydroxyl group-containing polymerizable unsaturated monomer (b), and optionally an acid group-containing polymerizable unsaturated monomer (a); and

(2) preparing a shell component resin (S) having an acid value of 30 to 150 and a hydroxyl group value of 10 to 100 by emulsion-polymerizing the acid group-containing polymerizable unsaturated monomer (a), the hydroxyl group-containing polymerizable unsaturated monomer (b), and the polymerizable unsaturated monomer (c) containing neither acid group nor hydroxyl group in the aqueous dispersion of the resin (C) prepared in step (1), thereby obtaining the core/shell-type aqueous resin dispersion.

By this production method, a core/shell-type aqueous resin dispersion with an initial viscosity of not less than 3,000 mPa·S after thickening with alkali and a structural viscosity index of not less than 250 after thickening with alkali, which is represented as a ratio between a low shear region (0.1 sec⁻¹) viscosity and a high shear region (100 sec⁻¹) viscosity:

(structural viscosity index)=(low shear region viscosity)/(high shear region viscosity)

is obtained.

The present invention is the method for producing a core/shell-type aqueous resin dispersion, wherein the polymerizable unsaturated monomer (c) containing neither acid group nor hydroxyl group includes at least one monomer selected from the group consisting of (meth)acrylates, styrenicmonomers, (meth)acrylonitrile and (meth)acrylamide.

The present invention is the method for producing a core/shell-type aqueous resin dispersion, wherein each of the monomer components is used so that the total weight Sw of the polymerizable unsaturated monomers in the preparation of the resin (S) and the total weight Cw of the polymerizable unsaturated monomers in the preparation of the resin (C) satisfy the relationship represented by the following equation:

10/100≦Sw/(Sw+Cw)≦50/100.

The invention is the method for producing a core/shell-type aqueous resin dispersion, wherein a cross-linkable monomer is used as an additional copolymerization component in the preparation of said resin (C).

The invention is the method for producing a core/shell-type aqueous resin dispersion, wherein a cross-linkable monomer is used as an additional copolymerization component in the preparation of said resin (S).

### MODES FOR CARRYING OUT THE INVENTION

Hereinafter, the present invention will be described in detail. It is noted that, in the specification, an “acrylic” polymerizable unsaturated monomer and a “methacrylic” polymerizable unsaturated monomer are combined to be referred to as a “(meth)acrylic” monomer.

First, each monomer used in the preparations of a core component resin (C) and a shell component resin (S) will be described.

The acid group-containing polymerizable unsaturated monomer (a) is a compound having not less than one unsaturated double bonds and acid groups in one molecule, respectively, and the acid group may, for example, be selected from carboxyl group, sulfonate group and phosphate group and the like.

Among the acid group-containing polymerizable unsaturated monomers (a), examples of the carboxyl group-containing monomer may include acrylic acid, methacrylic acid, crotonic acid, ethacrylic acid, propylacrylic acid, isopropylacrylic acid, itaconic acid, maleic anhydride, fumaric acid and the like. Examples of the sulfonate group-containing monomer may include t-butylacrylamidesulfonic acid and the like, while examples of the phosphate group-containing monomer may include Light Ester PM (manufactured by KYOEISHA CHEMICAL, Co., Ltd.) and the like. One kind or two or more kinds of these may be suitably used alone or in combination thereof.

Examples of the hydroxyl group-containing polymerizable unsaturated monomer (b) may include 2-hydroxyethyl acrylate, 2-hydroxyethyl methacrylate, hydroxypropyl acrylate, hydroxypropyl methacrylate, hydroxybutyl acrylate, hydroxybutyl methacrylate, N-methylol acrylamide, allyl alcohol, ε-caprolactone-modified acrylic monomer and the like. One kind or two or more kinds of these may be suitably used alone or in combination thereof.

Examples of the ε-caprolactone-modified acrylic monomer may include “PLACCEL FA-1”, “PLACCEL FA-2”, “PLACCEL FA-3”, “PLACCEL FA-4”, “PLACCEL FA-5”, “PLACCEL FM-1”, “PLACCEL FM-2”, “PLACCEL FM-3”, “PLACCEL FM-4”, “PLACCEL FM-5” manufactured by Daicel Chemical Industries, Ltd. and the like.

For the polymerizable unsaturated monomer (c) having neither acid group nor hydroxyl group (hereinafter, sometimes referred to as “other polymerizable unsaturated monomer (c)”), a (meth)acrylate may be mainly used, and a styrenic monomer may be suitably used.

For (meth)acrylate monomer, a monoester of a monohydric alcohol having 1 to 24 carbon atoms with acrylic acid or methacrylic acid may be preferably used and examples thereof include methyl (meth)acrylate, ethyl (meth)acrylate, propyl (meth)acrylate, n-butyl (meth)acrylate, isobutyl (meth)acrylate, t-butyl (meth)acrylate, 2-ethylhexyl (meth)acrylate, n-octyl (meth)acrylate, lauryl (meth)acrylate, stearyl (meth)acrylate and the like. One kind or two or more kinds of these may be suitably used alone or in combination.

For styrenic monomer, in addition to styrene, α-methylstyrene and the like may be used. For other monomers, for example, monomers such as (meth)acrylonitrile and (meth)acrylamide may also be used in suitable amounts appropriately.

Then, the core/shell-type aqueous resin dispersion liquid will be described.

In the present invention, a core part mainly comprises a core component resin (C) having an acid value of not more than 20 mgKOH/g, preferably 0 to 10 mgKOH/g and a hydroxyl group value of not more than 100 mgKOH/g, preferably 20 to 80 mgKOH/g, and emulsion-polymerized from a polymerizable unsaturated monomer (c) having neither acid group nor hydroxyl group, and optionally a hydroxyl group-containing polymerizable unsaturated monomer (b), and optionally an acid group-containing polymerizable unsaturated monomer (a) to emulsion polymerization.

An acid value of the resin (C) exceeding 20 mgKOH/g causes increased change with time in the viscosity of an aqueous resin dispersion obtained after being thickened by adding an alkali to the dispersion, resulting in a problematically poor stability.

A hydroxyl group value of the resin (C) exceeding 100 mgKOH/g causes a poor water resistance of the coating film and a poor compatibility with a melamine resin which is added as a curing agent in the use of the aqueous resin dispersion, resulting in increased strain of the coating film and irregularly proceeding of curing reaction, which leads to reduction of various strength characteristics of the coating film, especially in the scratch resistance and the acid resistance. On the other hand, a lower hydroxyl group content in the resin (C) allows the curing reaction with the melamine resin in the use of the aqueous resin dispersion to occur locally in the shell part of an emulsion particle, resulting in an irregularly structured film coating, which may cause an adverse effect for example on a mechanical strength. From this point of view, the hydroxyl group value of the resin (C) is preferably not less than 20 mgKOH/g, and thus preferably from not less than 20 mgKOH/g to not more than 80 mgKOH/g.

Thus, in the emulsion polymerization of the core component resin (C), the acid group-containing monomer (a) and the hydroxyl group-containing monomer (b) are optional components. Upon using the acid group-containing monomer (a), the amount should be determined so that the resultant resin (C) has an acid value of not more than 20 mgKOH/g, preferably not more than 10 mgKOH/g. Upon using the hydroxyl group-containing monomer (b), the amount should be determined so that the resultant resin (C) has a hydroxyl group value of not more than 100 mgKOH/g, preferably from not less than 20 mgKOH/g to not more than 80 mgKOH/g.

In the present invention, a shell mainly comprises a resin (S) having an acid value of 30 to 150 mgKOH/g, preferably 40 to 130 mgKOH/g and a hydroxyl group value of 10 to 100 mgKOH/g, preferably 30 to 80 mgKOH/g, emulsion-polymerized from an acid group-containing polymerizable unsaturated monomer (a), a hydroxyl group-containing polymerizable unsaturated monomer (b), and a polymerizable unsaturated monomer (c) having neither acid group nor hydroxyl group.

An acid value of the resin (S) smaller than 30 causes insufficient thickening upon addition of an alkali to the aqueous resin dispersion obtained finally, resulting in a difficulty in obtaining expected viscosity and structural viscosity. On the other hand, an acid value exceeding 150 causes undesirable reduction in the water resistance of the coating film. A hydroxyl group value of the resin (S) smaller than 10 causes insufficient curing reaction with a melamine resin added as a curing agent in various usages of the finally obtained aqueous resin dispersion, resulting in deterioration of various strength characteristics of the coating film especially in the scratch resistance and the acid resistance. On the other hand, a hydroxyl group value exceeding 100 causes reduced compatibility with the melamine resin, resulting in an increased strain of the coating film, which leads to undesirable reduction in the water resistance.

For preparing the resin (S), the acid group-containing polymerizable unsaturated monomer (a), a hydroxyl group-containing polymerizable unsaturated monomer (b), and any other polymerizable unsaturated monomer (c) are used in such a ratio that both of the acid value and hydroxyl group value of the resin (S) obtained are within the above described ranges.

In the present invention, in the preparation of the resin (C) and in the preparation of the resin (S), the acid group-containing polymerizable unsaturated monomer (a), the hydroxyl group-containing polymerizable unsaturated monomer (b), and any other polymerizable unsaturated monomer (c) is respectively used any of those selected from monomers (a), (b) and (c) exemplified above. Thus, in the preparation of the resin (C) and in the preparation of the resin (S), the same monomer (c) may be selected or different monomers (c) may be selected. The same is applied to the monomers (a) and (b).

In the present invention, it is preferable that each monomer component is used so that the total weight Sw of the polymerizable unsaturated monomers in the preparation of the shell component resin (S) and the total weight Cw of the polymerizable unsaturated monomers in the preparation of the core component resin (C) satisfy the relationship represented by the following equation:

10/100≦Sw/(Sw+Cw)≦50/100.

A value of Sw lower than the range specified above is undesirable because it tends to cause a poor alkali thickening performance of an aqueous resin dispersion obtained finally. On the other hand, a value of Sw exceeding the range specified above is undesirable because it tends to cause reduction in the water resistance, although it gives a sufficient alkali thickening performance. It is further preferable to use each monomer component so that the equation:

20/100≦Sw/(Sw+Cw)≦40/100

is satisfied.

In the present invention, firstly, emulsion-polymerization for the core component resin (C) is effected.

In the emulsion polymerization of the core component resin (C), the acid group-containing polymerizable unsaturated monomer (a) (if necessary), the hydroxyl group-containing polymerizable unsaturated monomer (b) (if necessary), and any other polymerizable unsaturated monomer (c) are used in such a ratio that the resin (C) has an acid value of not more than 20 mgKOH/g and a hydroxyl group value of not more than 100 mgKOH/g, and the copolymerization is performed by an emulsion polymerization method employed in emulsion polymerization of an ordinary acrylic resin or vinylic resin.

The copolymerization may be performed, for example, by heating the above described monomer components with stirring in the presence of a radical polymerization initiator and an emulsifier at a temperature of about 30 to 100° C. The reaction time is preferably 1 to 10 hours, while the reaction temperature is adjusted by adding the monomer mixture solution at once or dropwise to a reaction vessel containing water and surfactant. After completion of the emulsion polymerization, it is also preferable to react any residual monomers by means of maturing (keeping at a constant temperature for a certain period). It is preferable in many cases to use with an auxiliary agent (chain transfer agent) for adjusting the molecular weight such as a mercaptan-type compound or lower alcohol during an emulsion polymerization upon proceeding the emulsion polymerization and upon various usages, then the auxiliary agent is optionally used with.

As the radical polymerization initiator, a known initiator used usually in the emulsion polymerization of an acrylic resin may be used. Specifically, as a water-soluble free radical polymerization initiator, a persulfate such as potassium persulfate, sodium persulfate and ammonium persulfate may be used alone or in combination with hydrogen peroxide and a reducing agent such as acidic sodium sulfite, sodium thiosulfate, Rongalit and ascorbic acid, which is referred to as a redox initiator, each being used in the form of an aqueous solution.

For emulsifier, an anionic or non-ionic emulsifier may be used, which is selected from micelle compounds each having, in its molecule, a hydrocarbon group having not less than 6 carbon atoms and a hydrophilic part such as carboxylate, sulfonate or sulfate. Among such compounds, examples of the anionic emulsifier include an alkaline metal salt or ammonium salt of a halfester of sulfuric acid with alkylphenols or higher alcohols; an alkaline metal salt or ammonium salt of an alkyl- or allyl-sulfonate; an alkaline metal salt or ammonium salt of a halfester of sulfuric acid with a polyoxyethylene alkylphenyl ether, polyoxyethylene alkyl ether or polyoxyethylene allyl ether and the like. Examples of the non-ionic emulsifier may include polyoxyethylene alkyl phenyl ether, polyoxyethylene alkyl ether or polyoxyethylene allyl ether and the like. In addition to these ordinary and commonly used anionic and non-ionic emulsifier, any of various anionic or non-ionic reactive emulsifier having in its molecule a radically polymerizable unsaturated double bond, i.e., having an acryl-, methacryl-, propenyl-, allyl-, allyl ether-, maleate-type groups may be used alone or in combination with each other.

As described above, the aqueous dispersion of the core component resin (C) is prepared. The weight average molecular weight of the resin (C) thus obtained is not limited particularly but usually about 50,000 to 1,000,000, for example about 100,000 to 700,000.

Then, emulsion polymerization for the shell component resin (S) is effected in the aqueous dispersion of the core component resin (C).

For emulsion polymerization of the shell component resin (S), the monomer components of the acid group-containing polymerizable unsaturated monomer (a), the hydroxyl group-containing polymerizable unsaturated monomer (b), and any other polymerizable unsaturated monomer (c) are used in such a ratio as to obtain the resin (S) having an acid value of 30 to 150 mgKOH/g and a hydroxy group value of 10 to 100 mgKOH/g, and the copolymerization is effected by an emulsion polymerization method similar to that in the emulsion polymerization of the core component resin (C).

The copolymerization may be effected for example by heating the monomer components described above with stirring in the aqueous dispersion of the core component resin (C) in the presence of a radical polymerization initiator and an emulsifier at a temperature of about 30 to 100° C. The reaction time is preferably 1 to 10 hours, while the reaction temperature is adjusted by adding the monomer mixture solution at once or dropwise to a reaction vessel where the core component resin was prepared. An auxiliary agent for adjusting the molecular weight such as a mercaptan-type compound or lower alcohol is employed during emulsion polymerization as appropriate depending on the intended physical characteristics. For radical polymerization initiator and the like, the same ones as employed for preparing the core component resin (C) may be used additionally.

With preparing the shell component resin (S) as described above, a core/shell-type aqueous resin dispersion of the present invention is obtained. The weight average molecular weight of the resin (S) thus obtained is not limited particularly but usually about 50,000 to 1,000,000, for example about 100,000 to 800,000.

In the present invention, in either or both of the preparations of the core component resin (C) and the shell component resin(S), a cross-linkable monomer may also preferably be used as a copolymerization component in addition to the above described monomers (a), (b) and (c). The resin is imparted with a cross-linking structure by copolymerizing a cross-linkable monomer, or imparted with the cross-linking structure by the reaction with cross-linking auxiliary agent upon forming coating film depending on the type of the cross-linkable monomer, resulting in a highly solvent-resistance coating film.

An increased solvent resistance of the coating film is highly beneficial. For example, in a case where an aqueous resin dispersion of the present invention is utilized as a waterborne base coating material in the formation of multilayer coating film on an automobile and the like, a clear coating material is coated on the base coating film once formed, and the surface of this base coating film can avoid any impairment or denatured layer formation owing to the solvents contained in the clear coating material and thus can reduce the interlayer diffused reflection between the base coating film and clear coating film, resulting in a multilayer coating film with an excellent appearance. An aqueous resin dispersion of the present invention can also be utilized in various usages involving exposure to or contact with a solvent.

For the cross-linkable monomer, a cross-linkable monomer having a polymerizable unsaturated group such as a carbonyl group-containing monomer, hydrolyzable silyl group-containing monomer, glycidyl group-containing monomer and any of various polyfunctional vinyl monomers may be used. N-Methylol (meth)acrylamide and N-methoxymethyl (meth)acrylamide are also cross-linkable, but to a rather less extent.

An example of the carbonyl group-containing monomer may include a keto group-containing monomer such as acrolein, diacetone (meth)acrylamide, acetoacetoxyethyl (meth)acrylate, formylstyrol, a vinylalkyl ketone having 4 to 7 carbon atoms (for example, vinylmethyl ketone, vinylethyl ketone, vinylbutyl ketone) and the like. Among those listed above, diacetone (meth)acrylamide is preferred. When using such a carbonyl group-containing monomer, a hydrazine-type compound as a cross-linking auxiliary agent is added to an aqueous resin dispersion to form the cross-linking structure upon forming a coating film.

Examples of the hydrazine-type compound may include a saturated aliphatic carboxylic acid dihydrazide having 2 to 18 carbon atoms such as oxalic acid dihydrazide, malonic acid dihydrazide, glutaric acid dihydrazide, succinic acid dihydrazide, adipic acid dihydrazide and sebacic acid dihydrazide; a monoolefinic unsaturated dicarboxylic acid dihydrazide such as maleic acid dihydrazide, fumaric acid dihydrazide and itaconic acid dihydrazide; phthalic acid dihydrazide, terephthalic acid dihydrazide, isophthalic acid dihydrazide and dihydrazide, trihydrazide or tetrahydrazide of pyromellitic acid; nitrile trihydrazide, citric acid trihydrazide, 1,2,4-benzene trihydrazide, ethylene diaminetetraaceticacidtetrahydrazide, 1,4,5,8-naphthoicacid tetrahydrazide and a polyhydrazide obtained by reacting an oligomer having a lower alkyl carboxylate group with hydrazine or hydrazine hydrate; carboxyl dihydrazide and bissemicarbazide; an aqueous polyfunctional semicarbazide obtained by reacting a diisocyanate such as hexamethylene diisocyanate and isophorone diisocyanate or a polyisocyanate compound derived therefrom with an excess of a hydrazine compound or dihydrazide listed above and the like.

An example of the hydrolyzable silyl group-containing monomer may include an alkoxysilyl group-containing monomer such as γ-(meth)acryloxypropylmethyldimethoxysilane, γ-(meth)acryloxypropylmethyldiethoxysilane, γ-(meth)acryloxypropyltriethoxysilane and the like.

Examples of the glycidyl group-containing monomer may include glycidyl (meth)acrylate, β-methylglycidyl (meth)acrylate, (3,4-epoxycyclohexyl)methyl (meth)acrylate, 3-chloro-2-hydroxypropyl (meth)acrylate and the like.

Examples of the polyfunctional vinylic monomer may include a divinyl compound such as divinylbenzene, ethylene glycol di(meth)acrylate, propylene glycol di(meth)acrylate, hexanediol di(meth)acrylate, diethylene glycol di(meth)acrylate, polyethylene glycol di(meth)acrylate, polypropylene glycol di(meth)acrylate, allyl (meth)acrylate, neopentyl glycol di(meth)acrylate and pentaerythritol di(meth)acrylate, and also include pentaerythritol tri(meth)acrylate, trimethyrol propane tri(meth)acrylate, dipentaerythritol hexa(meth)acrylate and the like.

Any of the cross-linkable monomers listed above may be used alone or in combination with each other. Among the cross-linkable monomers listed above, carbonyl group-containing monomers and hydrolyzable silyl group-containing monomers are preferable at the point of the improving effect of the solvent resistance of a resultant coating film.

When using the cross-linkable monomer in the preparation processes of the core component resins (C) and the shell component resin (S), the cross-linkable monomer is used in a range of 0.5 to 10% by weight, preferably 1 to 8% by weight based on the total amount of the above described monomers (a), (b) and (c). With the amount of this range, it is possible to obtain a cross-linking structure of the resins (C) and (S) and also to obtain the improving effect of solvent resistance of the coating film, although the amount may vary depending on the type of the monomers. An amount less than the range specified above may cause a difficulty in obtaining the improving effect of solvent resistance of the coating film, while an amount exceeding the range specified above may cause problematic gelling during the manufacturing process of the resins or may cause problematically irregular coating film even if there is no problem in the manufacturing processes of the resins.

The introduction of the cross-linking structure may be performed in both of the core component resin (C) and the shell component resin (S) or in any one of them. In the case where the cross-linking structure is introduced into only one of the resins, when Sw≦Cw, a higher improving effect of solvent resistance of the coating film may be obtained by introducing the cross-linking structure into the resin (C) than into the resin (S). In the case where the cross-linking structure is introduced into both of the resins (C) and (S), when a carbonyl group-containing monomer is used as a cross-linkable monomer, the cross-linking structure is formed readily even between the resins (C) and (S) as a result of the effect of a hydrazine-type compound upon forming a coating film.

The resultant core/shell-type aqueous resin dispersion may be sometimes neutralized a part of the acid groups in the resin for the purpose of ensuring the stability. A basic compound used in the neutralization is preferably monomethylamine, dimethylamine, trimethylamine, monoethylamine, triethylamine, monoisopropylamine, diethylene triamine, triethylene triamine, triethylene tetramine, monoethanolamine, diethanolamine, triethanolamine, monoisopropanolamine, diisopropanolamine, dimethylethanolamine, 2-aminomethylpropanol, morpholin, methylmorpholin, piperazine, ammonia, sodium hydroxide, potassium hydroxide, lithium hydroxide and the like.

As described above, a core/shell-type aqueous resin dispersion of the present invention is obtained.

A core/shell-type aqueous resin dispersion of the present invention has an initial viscosity of not less than 3,000 mPa·S after thickening with alkali. The initial viscosity after thickening with alkali herein means a viscosity measured by type-B viscometer, of an initial sample which has been allowed to stand for 24 hours at 20° C. after adding an alkali to an aqueous resin dispersion having a nonvolatile content adjusted to 20% by weight and adjusting pH to 8.2. The initial viscosity after thickening with alkali less than 3,000 mPa·S causes increased sagging of the resin solution along the vertical surface and deteriorated orientation of an aluminum pigment in automobile coating material, resulting in poor appearance. The initial viscosity after thickening with alkali is not more than 20,000 mPa·S. The initial viscosity exceeding 20,000 mPa·S causes reduction in the extension or fluidity of the resin solution, resulting in poor workability and difficulty in increasing the nonvolatile content of the coating material. The initial viscosity after thickening with alkali is preferably from not less than 5,000 mPa·S to not more than 20,000 mPa·S, more preferably from not less than 7,000 mPa·S to not more than 18,000 mPa·S.

It is practically preferable that, as the change with time in the viscosity after thickening with alkali, the increase in the viscosity after allowing to stand for 1 week is within 10% of the initial viscosity.

In the aqueous resin dispersion of the present invention, a structural viscosity index, which is represented as a ratio between a low shear region (0.1 sec⁻¹) viscosity and a high shear region (100 sec⁻¹) viscosity:

(structural viscosity index)=(low shear region viscosity)/(high shear region viscosity),

is not less than 250, preferably not less than 700, and more preferably not less than 1,000. The low shear region (0.1 sec⁻¹) viscosity and the high shear region (100 sec⁻¹) viscosity herein mean the viscosity values of the same initial sample as above described after being thickened with alkali, which are measured using a viscoelastivity meter at 0.1 sec⁻¹ and 100 sec⁻¹, respectively.

A structural viscosity index less than 250 causes increased sagging of the resin solution along the vertical surface and deteriorated orientation of an aluminum pigment in automobile coating material, resulting in poor appearance or finish. The upper limit of the structural viscosity index is not specified particularly, and a higher index is more preferable, provided that a low shear region (0.1 sec⁻¹) viscosity which will be described below is within the preferable range.

In the present invention, the low shear region (0.1 sec⁻¹) viscosity is preferably from not less than 5,000 Pa·S to not more than 20,000 Pa·S, more preferably from not less than 7,000 Pa·S to not more than 18,000 Pa·S. A low shear region viscosity less than 5,000 Pa·S causes deteriorated sagging resistance of the resin solution along the vertical surface and deteriorated orientation of an aluminum pigment in automobile coating material, resulting in poor appearance. On the other hand, a viscosity exceeding 20,000 Pa·S causes a reduction in the extension or fluidity of the resin solution, resulting in poor workability and difficulty in increasing the nonvolatile content of the coating material, thereby leading to a problematically prolonged drying time.

In the present invention, the high shear region (100 sec⁻¹) viscosity is preferably not more than 20 Pa·S, more preferably not more than 10 Pa·S. A high shear region viscosity exceeding 20 Pa·S causes a poor spraying performance upon coating, resulting in problematically poor workability. In this point of view, a lower high shear region viscosity is more preferable, but is accompanied with corresponding reduction in the low shear region viscosity, so the high shear region viscosity should be adjusted so that the low shear region viscosity is in the preferable range specified above. Provided that the low shear region viscosity is within the above described preferable range, a lower high shear region viscosity is more preferable. It is preferable that the ratio between the low shear region viscosity and the high shear region viscosity is not less than 700, more preferably not less than 1,000.

### EXAMPLES

Hereinafter, the present invention will be described in the following Examples, which is not limited thereto. In the following description, terms “parts” and “%” are based on weight unless otherwise indicated.

### Example 1

(Production of Core/Shell Emulsion)

An ordinary reaction vessel for producing an acrylic resin equipped with a stirrer, thermometer, dropping funnel, condenser and nitrogen inlet was charged with 620 parts of water and 8 parts of Newcol 293 (Nippon Nyukazai Co., Ltd.) and heated to 75° C. 0.5 part of APS (ammonium persulfate) was added as polymerization initiator and the monomer mixture which will be described below (acid value of core resin (C): 3.7 mgKOH/g, hydroxyl group value: 20 mgKOH/g) was added dropwise over a period of 3 hours with stirring. Simultaneously with the dropwise addition of the monomers, 0.3 part of APS dissolved in 50 parts of water was added dropwise uniformly until completion of dropping of the monomers of the shell resin (S) in the subsequent step.

After completion of dropping of the monomers, the reaction was continued further for 1 hour at 80° C.

| | | |
|---|---|---|
| Methyl methacrylate | 120 | Parts |
| n-Butyl acrylate | 80 | Parts |
| 2-Hydroxyethyl methacrylate | 10 | Parts |
| Acrylic acid | 1 | Part |

Subsequently, the reaction vessel was kept at 80° C. while adding the monomer mixture shown below (acid value of shell resin (S): 69 mgKOH/g, hydroxyl group value: 48 mgKOH/g) dropwise over a period of 2 hours. Then the reaction mixture was kept at 80° C. for further 1 hour to exert the maturing reaction followed by cooling.

| | | |
|---|---|---|
| Methyl methacrylate | 40 | Parts |
| n-Butyl acrylate | 32 | Parts |
| 2-Hydroxyethyl methacrylate | 10 | Parts |
| Acrylic acid | 8 | Parts |

After cooling, a mixture of 3 parts of dimethyl aminoethanol and 30 parts of water was added, and then 3 parts of adipic acid dihydrazide was added to obtain an aqueous resin dispersion having a nonvolatile content of 30% by weight.

(Testing Method)

The resultant aqueous resin dispersion was evaluated for its performance.

1. Alkali Thickening Performance and Change with Time in Viscosity

The aqueous resin dispersion (C) was diluted with water to the nonvolatile content of 20% by weight, and was added dropwise with a 10% by weight aqueous solution of dimethyl aminoethanol while stirring, and the solution was adjusted pH to 8.2 and allowed to stand at 20° C. for 24 hours. This initial sample after alkali thickening was examined for the viscosity using a type-B viscometer. A roter No.4 was used at 23° C. at the rotation speed of 6 rpm.

In Example 1, the initial viscosity was 8,840 mPa·S. The viscosity of the sample after allowing to stand at 20° C. for 1 week was 8,920 mPa·S. Thus, there was almost no change with time in the viscosity after alkali thickening.

2. Structural Viscosity After Alkali Thickening

The same initial sample after alkali thickening as that in Section 1 described above was examined for the viscoelastivity at 25° C. using a viscoelasticity meter PHYSICA UDS200 (Nihon SiberHegner K. K.). The viscosity (Pa·S) at 0.1 sec⁻¹ was measured in a low shear region, while the viscosity (Pa·S) at 100 sec⁻¹ was measured in a high shear region.

In Example 1, the low shear region viscosity was 7,860 Pa·S and the high shear region viscosity was 4.6 Pa·S. The structural viscosity index was 1,710.

3. Warm Water Resistance Test of Coating Film

The aqueous resin dispersion (C) having a nonvolatile content adjusted to 20% by weight was applied onto an acrylic plate, dried at 105° C. for 3 minutes, and the acrylic plate was immersed in warm water at 60° C. for 7 days and then examined for any whitening of the coating film. The evaluation was made according to the following criteria.

◯: No whitening

Δ: Partially whitening

×: Entirely whitening

In Example 1, no whitening was observed in the coating film of the aqueous resin dispersion.

### Examples 2 to 6, Comparative Examples 1 to 6

In Examples 2 to 6 and Comparative Examples 1 to 6, respective aqueous resin dispersions were produced in the same manner as that in Example 1 except for changing the monomer composition of the core resin (C) and the shell resin (S) as indicated in Table 1 and Table 2, respectively. Each aqueous resin dispersion thus obtained was evaluated for its performance in the same manner as the Testing method 1 to 3 in Example 1. The results of the evaluation are shown in Table 3. In Tables 1 and 2, an acid value and a hydroxyl group value were obtained by the calculation from the amount of each polymerizable unsaturated monomer contained in the monomer mixture, and represented as being rounded at the decimal point.

The abbreviations in Tables 1 and 2 are as shown below.

MMA: Methyl methacrylate

S: Styrene

BA: Butyl acrylate

EA: Ethyl acrylate

MAA: Methacrylic acid

AA: Acrylic acid

HEMA: 2-Hydroxyethyl methacrylate

HEA: 2-Hydroxyethyl acrylate

TABLE 1

| | Monomer composition for emulsion | | | | | | | | | |
|---|---|---|---|---|---|---|---|---|---|---|
| | polymerization of core resin (C) | | | | | | | | Core resin (C) | |
| | (parts by weight) | | | | | | | | Acid | Hydroxyl |
| | MMA | S | BA | EA | MAA | AA | HEMA | HEA | value | group value |
| Example 1 | 120 | 0 | 80 | 0 | 0 | 1 | 10 | 0 | 4 | 20 |
| Example 2 | 68 | 20 | 100 | 0 | 0 | 3 | 20 | 0 | 11 | 41 |
| Example 3 | 30 | 20 | 0 | 140 | 0 | 0 | 0 | 21 | 0 | 48 |
| Example 4 | 50 | 0 | 0 | 135 | 5 | 0 | 0 | 21 | 15 | 48 |
| Example 5 | 89 | 0 | 100 | 0 | 0 | 2 | 20 | 0 | 7 | 41 |
| Example 6 | 50 | 0 | 0 | 139 | 1 | 0 | 21 | 0 | 3 | 43 |
| Comparative | 90 | 0 | 100 | 0 | 1 | 0 | 20 | 0 | 3 | 41 |
| Example 1 | | | | | | | | | | |
| Comparative | 60 | 0 | 0 | 120 | 10 | 0 | 0 | 21 | 30 | 48 |
| Example 2 | | | | | | | | | | |
| Comparative | 66 | 20 | 100 | 0 | 0 | 5 | 20 | 0 | 18 | 41 |
| Example 3 | | | | | | | | | | |
| Comparative | 30 | 20 | 0 | 140 | 0 | 0 | 0 | 21 | 0 | 48 |
| Example 4 | | | | | | | | | | |
| Comparative | 50 | 0 | 0 | 135 | 5 | 0 | 0 | 21 | 15 | 48 |
| Example 5 | | | | | | | | | | |
| Comparative | 20 | 20 | 120 | 0 | 0 | 0 | 0 | 51 | 0 | 117 |
| Example 6 | | | | | | | | | | |

TABLE 2

| | Monomer composition for emulsion | | | | | | | | | |
|---|---|---|---|---|---|---|---|---|---|---|
| | polymerization of shell resin (S) | | | | | | | | Shell resin (S) | |
| | (parts by weight) | | | | | | | | Acid | Hydroxyl |
| | MMA | S | BA | EA | MAA | AA | HEMA | HEA | value | group value |
| Example 1 | 40 | 0 | 32 | 0 | 0 | 8 | 10 | 0 | 69 | 48 |
| Example 2 | 40 | 0 | 25 | 0 | 0 | 10 | 15 | 0 | 86 | 72 |
| Example 3 | 20 | 10 | 0 | 35 | 10 | 0 | 0 | 15 | 72 | 80 |
| Example 4 | 25 | 0 | 0 | 45 | 10 | 0 | 0 | 10 | 72 | 54 |
| Example 5 | 33 | 0 | 35 | 0 | 0 | 12 | 10 | 0 | 104 | 48 |
| Example 6 | 38 | 0 | 30 | 0 | 10 | 0 | 0 | 12 | 72 | 57 |
| Comparative | 35 | 0 | 25 | 0 | 0 | 20 | 10 | 0 | 173 | 48 |
| Example 1 | | | | | | | | | | |
| Comparative | 25 | 0 | 0 | 45 | 10 | 0 | 0 | 10 | 72 | 54 |
| Example 2 | | | | | | | | | | |
| Comparative | 41 | 0 | 30 | 0 | 0 | 3 | 15 | 0 | 26 | 72 |
| Example 3 | | | | | | | | | | |
| Comparative | 20 | 10 | 0 | 20 | 10 | 0 | 0 | 30 | 72 | 162 |
| Example 4 | | | | | | | | | | |
| Comparative | 30 | 0 | 0 | 50 | 10 | 0 | 0 | 0 | 72 | 0 |
| Example 5 | | | | | | | | | | |
| Comparative | 22 | 10 | 0 | 35 | 0 | 8 | 0 | 15 | 70 | 81 |
| Example 6 | | | | | | | | | | |

TABLE 3
Aqueous resin dispersion performance evaluation

| | Alkali thickening | | | | | |
|---|---|---|---|---|---|---|
| | performance | | Structural viscosity of alkali-thickened resin | | | |
| | and change with time | | Low shear region | High shear region | Structural viscosity | Water |
| | Initial | Viscosity | (0.1 sec-1) | (100 sec-1) | index, | resistance |
| | viscosity | after 1 week | viscosity | viscosity | Low shear/High shear | of coating |
| | (mPa · s) | (mPa · s) | (Pa · s) | (Pa · s) | viscosity ratio | film |
| Example 1 | 8,840 | 8,920 | 7,860 | 4.6 | 1,710 | ◯ |
| Example 2 | 10,400 | 11,200 | 10,400 | 8.6 | 1,210 | ◯ |
| Example 3 | 9,880 | 9,920 | 9,650 | 6.2 | 1,560 | ◯ |
| Example 4 | 9,920 | 10,400 | 10,300 | 7.2 | 1,430 | ◯ |
| Example 5 | 12,800 | 13,800 | 10,300 | 9 | 1,120 | ◯ |
| Example 6 | 9,860 | 9,860 | 9,820 | 5.8 | 1,690 | ◯ |
| Comparative | 93,200 | 96,700 | 67,300 | 46 | 1,460 | X |
| Example 1 | | | | | | |
| Comparative | 26,800 | 112,000 | 42,300 | 69 | 610 | X |
| Example 2 | | | | | | |
| Comparative | 1,360 | 2,470 | 130 | 0.2 | 650 | ◯ |
| Example 3 | | | | | | |
| Comparative | 5,760 | 6,340 | 4,780 | 22 | 220 | X |
| Example 4 | | | | | | |
| Comparative | 14,300 | 17,800 | 18,200 | 26 | 700 | ◯ |
| Example 5 | | | | | | |
| Comparative | 4,230 | 84,460 | 3,860 | 16 | 240 | Δ |
| Example 6 | | | | | | |

As can be seen from Tables 1 to 3, each aqueous resin dispersion in Examples 1 to 6 acquired a high viscosity by alkali thickening, exhibited an excellent stability with almost no change with time in the viscosity after thickening as well as a high structural viscosity after alkali thickening, and have high water resistance of the coating film. As described above, each aqueous resin dispersion in Examples 1 to 6 had an excellent performance even with a relatively low acid value.

On the contrary, Comparative Example 1 exhibited an excessively high alkali thickening performance, had a poor workability and exhibited considerably poor water resistance of the coating film. In Comparative Example 2, the resin (C) had a excessively high acid value, underwent a marked change with time after alkali thickening, and exhibited a poor stability. In Comparative Example 3, no high viscosity was obtained even after alkali thickening. In Comparative Example 4, the hydroxyl group value of the resin (S) was excessively high, resulting in a poor structural viscosity and poor water resistance of the coating film. In Comparative Example 5, change with time after alkali thickening was substantial. In Comparative Example 6, the hydroxyl group value of the resin (C) was excessively high, resulting in marked change with time after alkali thickening and poor structural viscosity, as well as poor water resistance of the coating film.

### Example 7

(Production of Core/Shell Emulsion)

An ordinary reaction vessel for producing an acrylic resin equipped with a stirrer, thermometer, dropping funnel, condenser and nitrogen inlet was charged with 620 parts of water and 8 parts of Newcol 293 (Nippon Nyukazai Co., Ltd.) and heated to 75° C. 0.5 part of APS (ammonium persulfate) was added as a polymerization initiator and the monomer mixture which will be described below (acid value of core resin (C): 3.7 mgKOH/g, hydroxyl group value: 20 mgKOH/g) was added dropwise over a period of 3 hours with stirring. Simultaneously with the dropwise addition of the monomers, 0.3 part of APS dissolved in 50 parts of water was added dropwise uniformly until completion of dropping of the monomers of the shell resin (S) in the subsequent step.

After completion of dropping of the monomers, the reaction was continued further for 1 hour at 80° C.

| | | |
|---|---|---|
| Methyl methacrylate | 117 | Parts |
| n-Butyl acrylate | 77 | Parts |
| Diacetone acrylamide | 6 | Parts |
| 2-Hydroxyethyl methacrylate | 10 | Parts |
| Acrylic acid | 1 | Part |

Subsequently, the reaction vessel was kept at 80° C. while adding the monomer mixture shown below (acid value of shell resin (S): 69 mgKOH/g, hydroxyl group value: 48 mgKOH/g) dropwise over a period of 2 hours. Then the reaction mixture was kept at 80° C. for further 1 hour to exert the maturing reaction followed by cooling.

| | | |
|---|---|---|
| Methyl methacrylate | 40 | Parts |
| n-Butyl acrylate | 32 | Parts |
| 2-Hydroxyethyl methacrylate | 10 | Parts |
| Acrylic acid | 8 | Parts |

After cooling, a mixture of 3 parts of dimethyl aminoethanol and 30 parts of water was added, and then 3 parts of adipic acid dihydrazide was added to obtain an aqueous resin dispersion having a nonvolatile content of 30% by weight.

### Example 8

An aqueous resin dispersion was produced in the same manner as that in Example 7 except for changing the emulsion polymerization monomer composition of the core resin (C) as shown in Table 4 and using 5 parts of adipic acid dihydrazide.

### Examples 9 to 13

Each aqueous resin dispersion was produced in the same manner as that in Example 7 except for changing the emulsion polymerization monomer composition of the core resin (C) as shown in Table 4 and using no adipic acid dihydrazide.

Each aqueous resin dispersion obtained in Examples 7 to 13 was evaluated for its performance in the same manner as the Testing method 1 to 3 in Example 1 and then further evaluated the solvent resistance of the resin coating film as described below.

4. Solvent Resistance Test of Coating Film

An aqueous resin dispersion (C) having a nonvolatile content adjusted to 20% by weight was applied onto an acrylic plate, dried at 105° C. for 3 minutes, and then a drop of MEK (methyl ethyl ketone) was dropped on this acrylic plate. The resin coating film was rubbed with a finger and the number of time of the rubbing action until the coating film was peeled off was counted. This number of time of rubbing was regarded as an index of the solvent resistance. The number of time of rubbing of not less than 5, preferably not less than 10 was regarded to indicate a practically very excellent solvent resistance. The aqueous resin dispersion (C) of Example 1 underwent the peel off of the coating film after one rubbing action.

The results of the performance evaluation are shown in Table 5. In Table 4, an acid value and a hydroxyl group value were obtained by the calculation from the amount of each polymerizable unsaturated monomer contained in the monomer mixture, and represented as being rounded at the decimal point. The abbreviations in Table 4 are as shown below. Other abbreviations are the same as that in Tables 1 and 2.

DAAAm: Diacetone acrylamide

KBM-502: Alkoxysilyl group-containing monomer manufactured by Shin-Etsu Chemical Co., Ltd.

KBM-502: Alkoxysilyl group-containing monomer manufactured by Shin-Etsu Chemical Co., Ltd.

N-MAM: N-Methylol acrylamide

GMA: Glycidyl methacrylate

FA-3: PLACCEL FA-3 (Daicel Chemical Industries, Ltd.)

TABLE 4

| | | | | | | | | | | | | | | | Core resin (C) | |
|---|---|---|---|---|---|---|---|---|---|---|---|---|---|---|---|---|
| | Monomer composition for emulsion polymerization of core resin (C) (part by weight) | | | | | | | | | | | | | | | Hydroxyl |
| | | | | | | | | | | | KBM- | KBM- | | | Acid | group |
| | MMA | S | BA | EA | MAA | AA | HEMA | HEA | FA-3 | DAAAm | 502 | 503 | N-MAM | GMA | value | value |
| Example 7* | 117 | 0 | 77 | 0 | 0 | 1 | 10 | 0 | 0 | 6 | 0 | 0 | 0 | 0 | 4 | 20 |
| Example 8* | 63 | 20 | 95 | 0 | 0 | 3 | 20 | 0 | 0 | 10 | 0 | 0 | 0 | 0 | 11 | 41 |
| Example 9 | 30 | 20 | 0 | 140 | 0 | 0 | 0 | 15 | 0 | 0 | 6 | 0 | 0 | 0 | 0 | 34 |
| Example 10 | 86 | 0 | 100 | 0 | 0 | 4 | 0 | 15 | 0 | 0 | 0 | 6 | 0 | 0 | 14 | 34 |
| Example 11 | 50 | 0 | 0 | 130 | 1 | 0 | 0 | 17 | 10 | 0 | 0 | 3 | 0 | 0 | 3 | 39 |
| Example 12 | 117 | 0 | 77 | 0 | 0 | 1 | 10 | 0 | 0 | 0 | 0 | 0 | 6 | 0 | 4 | 20 |
| Example 13 | 63 | 20 | 95 | 0 | 0 | 3 | 20 | 0 | 0 | 0 | 0 | 0 | 0 | 10 | 11 | 41 |

*In Examples 7 and 8, 3 parts and 5 parts, respectively, of adipic acid dihydrazide were added after the polymerization of the shell resin (S).

TABLE 5
Aqueous resin dispersion performance evaluation

| | Alkali thickening | | | | | | Solvent |
|---|---|---|---|---|---|---|---|
| | performance | | Structural viscosity of alkali-thickened resin | | | | resistance |
| | and change with time | | Low shear region | High shear region | Structural viscosity | Water | of coating |
| | Initial | Viscosity after | (0.1 sec-1) | (100 sec-1) | index, | resistance | film, |
| | viscosity | 1 week | viscosity | viscosity | Low shear/High shear | of coating | MEK rubbing |
| | (mPa · s) | (mPa · s) | (Pa · s) | (Pa · s) | viscosity ratio | film | number |
| Example 7 | 9,120 | 9,140 | 8,140 | 6.3 | 1,292 | ◯ | 64 |
| Example 8 | 9,860 | 9,880 | 8,680 | 7.8 | 1,113 | ◯ | 81 |
| Example 9 | 9,020 | 9,020 | 8,360 | 6.2 | 1,348 | ◯ | 56 |
| Example 10 | 10,300 | 10,800 | 9,230 | 8.2 | 1,126 | ◯ | 60 |
| Example 11 | 9,230 | 9,260 | 8,260 | 5.8 | 1,588 | ◯ | 38 |
| Example 12 | 9,160 | 9,200 | 8,330 | 6.8 | 1,225 | ◯ | 6 |
| Example 13 | 9,880 | 9,920 | 8,820 | 6.6 | 1,336 | ◯ | 8 |

As can be seen from Tables 4 and 5, each aqueous resin dispersion in Examples 7 to 13 acquired a high viscosity by alkali thickening, exhibited an excellent stability with almost no change with time in the viscosity after thickening as well as a high structural viscosity after alkali thickening, and have high water resistance and solvent resistance of the coating film. A considerably high solvent resistance was exhibited especially by each of the aqueous resin dispersions in Examples 7 to 11 which used diacetone acrylamide or a hydrolyzable silyl group-containing monomer as a cross-linkable monomer.

Industrial Applicability

According to the present invention, a core/shell-type aqueous resin dispersion is produced by performing emulsion polymerization in preparation process of the core component resin so that the core component resin having a considerably low acid value and an appropriate hydroxyl group value is obtained, and by performing emulsion polymerization in the resultant core component resin aqueous dispersion in preparation process of the shell component resin so that a shell component resin having a relatively low acid value and an appropriate hydroxy group value can be obtained. The aqueous resin dispersion of the present invention obtained by this method exhibits an excellent alkali thickening performance and a high structural viscosity. Accordingly, when an aqueous resin dispersion of the present invention is used in fiber implantation or automobile coating process, the workability is excellent, the final product has an excellent appearance and excellent water resistance of the coating film.

According to the present invention, the acid value of a core component resin is adjusted to a low value, which enables an aqueous resin dispersion of the present invention to suppress change with time in the viscosity after alkali thickening and to exhibit an excellent stability. An aqueous resin dispersion of the present invention also exhibits an excellent compatibility with melamine and an excellent curing reactivity with melamine due to an appropriate level of the hydroxyl group used in the core component resin and the shell component resin, thereby imparting the coating film with excellent acid resistance and scratch resistance.

In addition, according to the present invention, by using a cross-linkable monomer as a copolymeric component in the preparation of a core composition resin (C) and/or the preparation of a shell composition resin (S), the coating film can be imparted with an excellent solvent resistance.

The present invention provides an aqueous resin dispersion having a relatively low acid value and high viscosity and structural viscosity after alkali neutralization, and a method for producing the same.

1. A core/shell-type aqueous resin dispersion comprising a core/shell-type resin including:
a core part comprising a resin (C) having an acid value of not more than 20 and a hydroxyl group value of not more than 100 and being emulsion-polymerized from a polymerizable unsaturated monomer (c) containing neither acid group nor hydroxyl group, and optionally a hydroxyl group-containing polymerizable unsaturated monomer (b), and optionally an acid group-containing polymerizable unsaturated monomer (a); and
a shell part comprising a resin (S) having an acid value of 30 to 150 and a hydroxyl group value of 10 to 100 and being emulsion-polymerized from the acid group-containing polymerizable unsaturated monomer (a), the hydroxyl group-containing polymerizable unsaturated monomer (b), and the polymerizable unsaturated monomer (c) containing neither acid group nor hydroxyl group,
wherein said core/shell-type aqueous resin dispersion has an initial viscosity of not less than 3,000 mPa·S after thickening with alkali, and a structural viscosity index of not less than 250 after thickening with alkali, which is represented as a ratio between a low shear region (0.1 sec⁻¹) viscosity and a high shear region (100 sec⁻¹) viscosity:
(structural viscosity index)=(low shear region viscosity)/(high shear region viscosity).

2. A core/shell-type aqueous resin dispersion obtained by:
(1) preparing an aqueous dispersion of a core component resin (C) having an acid value of not more than 20 and a hydroxyl group value of not more than 100 by emulsion-polymerizing a polymerizable unsaturated monomer (c) containing neither acid group nor hydroxyl group, and optionally a hydroxyl group-containing polymerizable unsaturated monomer (b), and optionally an acid group-containing polymerizable unsaturated monomer (a); and
(2) preparing a shell component resin (S) having an acid value of 30 to 150 and a hydroxyl group value of 10 to 100 by emulsion-polymerizing the acid group-containing polymerizable unsaturated monomer (a), the hydroxyl group-containing polymerizable unsaturated monomer (b), and the polymerizable unsaturated monomer (c) containing neither acid group nor hydroxyl group in the aqueous dispersion of the resin (C) prepared in step (1);
wherein said core/shell-type aqueous resin dispersion has an initial viscosity of not less than 3,000 mPa·S after thickening with alkali, and a structural viscosity index of not less than 250 after thickening with alkali, which is represented as a ratio between a low shear region (0.1 sec⁻¹) viscosity and a high shear region (100 sec⁻¹):
(structural viscosity index)=(low shear region viscosity)/(high shear region viscosity).

3. The core/shell-type aqueous resin dispersion according to claim 1, wherein said polymerizable unsaturated monomer (c) containing neither acid group nor hydroxyl group includes at least one monomer selected from the group consisting of (meth)acrylates, styrenic monomers, (meth)acrylonitrile and (meth)acrylamide.

4. The core/shell-type aqueous resin dispersion according to claim 1, wherein the total weight Sw of the polymerizable unsaturated monomers used in the preparation of said resin (S) and the total weight Cw of the polymerizable unsaturated monomers used in the preparation of said resin (C) satisfy the relationship represented by the following equation:
10/100≦Sw/(Sw+Cw)≦50/100.

5. The core/shell-type aqueous resin dispersion according to claim 1, wherein a cross-linkable monomer is used as an additional copolymerization component in the preparation of said resin (C).

6. The core/shell-type aqueous resin dispersion according to claim 1, wherein a cross-linkable monomer is used as an additional copolymerization component in the preparation of said resin (S).

7. A method for producing a core/shell-type aqueous resin dispersion comprising the steps of:
(1) preparing an aqueous dispersion of a core component resin (C) having an acid value of not more than 20 and a hydroxyl group value of not more than 100 by emulsion-polymerizing a polymerizable unsaturated monomer (c) containing neither acid group nor hydroxyl group, and optionally a hydroxyl group-containing polymerizable unsaturated monomer (b), and optionally an acid group-containing polymerizable unsaturated monomer (a); and
(2) preparing a shell component resin (S) having an acid value of 30 to 150 and a hydroxyl group value of 10 to 100 by emulsion-polymerizing the acid group-containing polymerizable unsaturated monomer (a), the hydroxyl group-containing polymerizable unsaturated monomer (b), and the polymerizable unsaturated monomer (c) containing neither acid group nor hydroxyl group in the aqueous dispersion of the resin (C) prepared in step (1), thereby obtaining the core/shell-type aqueous resin dispersion.

8. The method for producing a core/shell-type aqueous resin dispersion according to claim 7, wherein a cross-linkable monomer is used as an additional copolymerization component in the preparation of said resin (C).

9. The method for producing a core/shell-type aqueous resin dispersion according to claim 7, wherein a cross-linkable monomer is used as an additional copolymerization component in the preparation of said resin (S).
